(19) United States
(12) Patent Application Publication
(10) Pub. No.: US 2016/0273532 A1
(43) Pub. Date: Sep. 22, 2016

(54) A COMPONENT WHICH CONDUCTS A HIGH-PRESSURE MEDIUM

(71) Applicant: ROBERT BOSCH GMBH, Stuttgart (DE)

(72) Inventors: Hagen Sassnick, Puch (AT); Matthias Herrmann, Saarbrücken (DE)

(21) Appl. No.: 15/029,354

(22) PCT Filed: Oct. 6, 2014
(86) PCT No.: PCT/EP2014/071337

§ 371 Date: Apr. 14, 2016

(30) Foreign Application Priority Data
Oct. 15, 2013 (AT) 0793/2013

(51) Int. Cl. F04B 53/16; F04B 17/05; F04B 53/14; F04B 7/02; F02M 55/02; F02M 59/46; F04B 53/10; F04B 9/04; F02M 59/10

(52) U.S. Cl. CPC F04B 53/162; F04B 9/042; F04B 17/05; F04B 53/14; F02M 59/102; F02M 55/025; F02M 59/46; F04B 53/1087; F04B 7/02

(57) ABSTRACT

In the case of a component which conducts high-pressure medium, comprising a first component (13) with at least one pressure duct (29) and a second component (2) with a pressure chamber (30), wherein an annular sealing surface (32), which surrounds the mouth(s) of the at least one pressure duct (29), of the first component (13) and an annular sealing surface (33), which surrounds the rim of the pressure chamber (30), of the second component (2) interact areally with one another to form a sealing point, wherein the cross-sectional area of the pressure duct (29) is smaller than the cross-sectional area of the pressure chamber (30), the pressure-induced radial expansion of the annular sealing surfaces (32, 33) is substantially equal.

### BACKGROUND OF THE INVENTION

The invention relates to a component or device which conducts a high-pressure medium, comprising a first component with at least one pressure duct and a second component with a pressure chamber, wherein an annular sealing surface, which surrounds the mouth(s) of the at least one pressure duct, of the first component and an annular sealing surface, which surrounds the rim of the pressure chamber (30), of the second component interact areally with one another, wherein the cross-sectional area of the pressure duct is smaller than the cross-sectional area of the pressure chamber.

Such a component or device can, for example, be designed as a pump element for a common rail high-pressure pump. Pump elements are generally equipped with a pump cylinder, a pump piston and a valve unit, wherein the valve unit has an intake valve and a pressure valve, in the case of which one intake or pressure valve member can respectively be pressed against an intake or pressure valve seat and the intake and the pressure member can be movably disposed in a valve carrier. During the downward stroke of the pump piston, medium is suctioned out of the suction chamber of the pump element; and medium is discharged via the pressure valve during the upward stroke of the pump piston. The suction chamber is connected to the intake valve via a suction bore, and a pump chamber of the pump element, which is configured in the pump cylinder, is connected to the pressure valve via at least one pressure duct. An annular sealing surface, which surrounds the mouths of the at least one pressure duct, of the valve carrier and an annular sealing surface, which surrounds the rim of the pump chamber, of the pump cylinder interact areally with one another to form a sealing point.

High-pressure pumps are, for example, used in internal combustion machines in order to bring fuel to a pressure suitable for the injection into the combustion chamber. In the case of diesel engines, which have a so-called common rail injection system, it is necessary to provide the high-pressure fuel stored in the rail for all operating states of the engine, said high-pressure pump being provided for this purpose. In order to facilitate a fast start-up of the engine, the maximum delivery rate of the high-pressure pump has to lie significantly above the full load charge required by the engine. On the other hand, only a small delivery rate of the high-pressure pump is required in a part load or no-load operation. The delivery rate of the high pressure pump into the rail is regulated by an electronically controlled metering unit, which determines the feed quantity to the high-pressure pump as a function of the fuel pressure in the rail/collector. As a result, only the quantity of high-pressure fuel required in each case is delivered.

A high-pressure pump consists of at least one pump element, which is driven via a roller tappet or directly by a cam shaft. On the intake side, a pre-supply pump, for example a gear type pump, supplies the fuel at a low pressure from the tank. On the pressure side, the compressed fuel moves across a collector into the distribution system or, respectively, via a line into the rail.

The high-pressure pump generally operates in such a way that the fuel quantity determined by the metering unit is suctioned from the pump suction chamber during the downward stroke of the pump piston and is subsequently pressed into the rail by means of the pressure valve during the upward stroke of the pump piston. As a result, the sealing point between the valve carrier and the pump cylinder is cyclically loaded due to change in pressure. The load occurs during each pumping process, wherein the amplitude of the load corresponds to a change in the pressure from the supply pressure of the high-pressure pump (<10 bar) to the respective system pressure of the common rail system (>2.000 bar). On account of the cyclical change in pressure, there is the danger that fuel partially infiltrates the high-pressure sealing surface during each pumping process and as a result flow erosion occurs. In addition, cyclical component expansions, which then particularly lead to relative movements at the interacting sealing surfaces, occur due to the cyclical change in pressure if the component expansion in the components involved varies to different degrees. The so-called fretting can thereby occur. Together with the locally usually high stresses on the sealing surfaces and with the flow erosion, this can lead to crack formations and component breakdown.

In the case of pump elements according to the prior art, as they are, for example, depicted in FIG. 1, the infiltration of the sealing surface and the fretting due, on the one hand, to stiffness differences within the valve carrier and, on the other hand, to different stiffnesses between the two components (valve carrier, pump cylinder) in the region of the sealing surface are promoted. In addition, locally high stresses occur at the high-pressure point as a result of the angle exaggeration and the processing process at the pump cylinder.

### SUMMARY OF THE INVENTION

It is therefore the aim of the invention to further modify a pump element such that the danger of a flow erosion and a crack formation at the sealing surface is reduced.

In order to meet this aim, the invention essentially consists of seeing that the pressure-induced radial expansion of the annular sealing surfaces is substantially equal. As a result, a relative displacement at the sealing surfaces, i.e. a sliding of the two sealing surfaces on one another, is prevented. In fact, the two sealing surfaces tend to roll off one another; thus enabling the so-called fretting to be prevented. The pressure-induced radial expansion of the two components can be equalized to each other in the region of the sealing surfaces by a series of constructive measures. For example, the component stiffness of one of the two components or of both components can be adapted.

Provision is preferably made for the mouth of the at least one pressure duct in the first component to be axially set back from the annular sealing surface. As a result, the pressure duct does not directly open out at the sealing surface but in an interstice that develops as a result of the axial displacement of the mouth of the at least one pressure duct to the rear. The interstice preferably has here an enlarged cross-sectional area with respect to the pressure duct, wherein said interstice is surrounded by the annular sealing surface. The arrangement of the interstice creates a pressure chamber, in which the existing, pulsating fluid pressure acts radially on the wall of the interstice and therefore in the sense of a larger component expansion than without said interstice.

In a particularly advantageous manner, the present invention can be implemented in a pump element for a common rail high-pressure pump. The second component is thereby formed from a pump cylinder of the pump element. The first component is formed from a valve carrier for the suction and/or pressure valve of the pump element. The pressure chamber of the second component is formed from a pump chamber of the pump element configured in the pump cylinder. The configuration is preferably implemented in this context in such a way that the pump element is formed by a pump cylinder, a pump piston and a valve unit, said valve unit having a suction valve and a pressure valve, in the case of which a suction or pressure valve member can respectively be pressed against a suction or pressure valve seat. The suction and the pressure valve member are movably arranged in a valve carrier, wherein medium is suctioned out of a suction chamber of the pump element via the suction valve during a downward stroke of the pump piston and medium is discharged via the pressure valve during an upward stroke of the pump piston, the suction chamber being connected to the suction valve via a suction bore passing through the valve carrier and a pump chamber configured in the pump cylinder being connected to the pressure valve via pressure ducts which extend transversely to the suction bore and are configured in the valve carrier. In so doing, the annular sealing surface of the valve carrier which surrounds the mouths of the pressure ducts and the annular sealing surface of the pump cylinder surrounding the rim of the pump chamber interact with each other.

In order to equalize the component stiffness of the valve carrier and the pump cylinder, provision can preferably be made for the material thickness provided between the suction bore and the sealing surface of the valve carrier, as seen in cross section, to be at least 1.25 times, preferably 1.5 times, the diameter of the suction bore. As a result of the material thickness of the valve carrier provided between the suction bore and the sealing surface being increased, as seen in cross section, with respect to the prior art, an increase in the stiffness of the valve carrier occurs in the region of the suction bore. This is of importance because the stiffness of the valve carrier is generally minimal in this region as a matter of principle.

A further measure consists of providing an annular, conical or convex surface at the transition between the cylindrical interior surface and the sealing surface of the pump cylinder, said annular, conical or convex surface widening out towards the sealing surface. As a result, the supporting effect of the pump cylinder on the inside diameter of the sealing surface is increased at the transition between the cylindrical interior surface and the sealing surface of the pump cylinder.

The result of the equalization of the component stiffnesses achieved by the measures mentioned above is, on the one hand, a homogenization of the surface pressure in the sealing region of the sealing surfaces and, on the other hand, an optimization of the stress distribution in the two affected components.

The inventive increasing of the component thickness between the suction bore and the sealing surface of the valve carrier makes it possible to allow the inlet bore leading to the suction chamber of the pump element to enter into said suction chamber at a higher location, wherein a configuration preferably results in which the inlet bore extends substantially coaxially in relation to the suction bore.

In the embodiments according to the prior art, an angle exaggeration is usually provided at the sealing surfaces which interact with one another in order to increase the surface pressure. The angle exaggeration is in this case carried out in such a way that the surface pressure arises on the inside diameter of the annular sealing surface and decreases in an outward direction. The angle exaggeration consists of a slightly conical configuration, i.e. a material thickness which becomes greater in the direction of the inside diameter, of the sealing surface, the maximum angle exaggeration or, respectively, material thickness being 10-20 μm. Deviating from the prior art, provision is made within the scope of a preferred embodiment of the invention for the sealing surface of the pump cylinder to have an angle exaggeration of 0-3 μm. As a result, the surface pressure maximum on the inside diameter of the sealing surface can be reduced, which also leads to a homogenization of the surface pressure in the high-pressure sealing region. By reducing the region of the angle exaggeration from 10-20 μm to 0-3 μm, a restriction of the dimensional tolerances of the corresponding components results because the value of the angle exaggeration only fluctuates between 0 and 3 μm.

A further reduction in the stress peaks on the sealing surfaces results according to a preferred modification by virtue of the fact that the sealing surfaces which interact with one another are machined by grinding. The use of a grinding process instead of the turning process used in the prior art improves the surface pressure peaks brought about by the turning grooves. The machining process of grinding furthermore promotes the reduction of the dispersion of the manufacturing dimensions with regard to the angle exaggeration mentioned above.

In order to increase the temperature resistance, a further preferred modification provides that the pump cylinder comprises the steel 100Cr6 (ISO 683-17). This steel has the following composition:

C: 0.93-1.05

Si: 0.15-0.35

Mn: 0.25-0.45

Cr: 1.35-1.60

### BRIEF DESCRIPTION OF THE DRAWINGS

The invention is subsequently explained in greater detail with the aid of the exemplary embodiments schematically depicted in the drawings. In the drawings:

FIG. 1 shows the basic construction of a high-pressure pump according to the prior art;

FIG. 2 shows a cross section through a valve unit of a pump element of FIG. 1; and

FIG. 3 shows a cross section through a pump element according to the invention.

### DETAILED DESCRIPTION

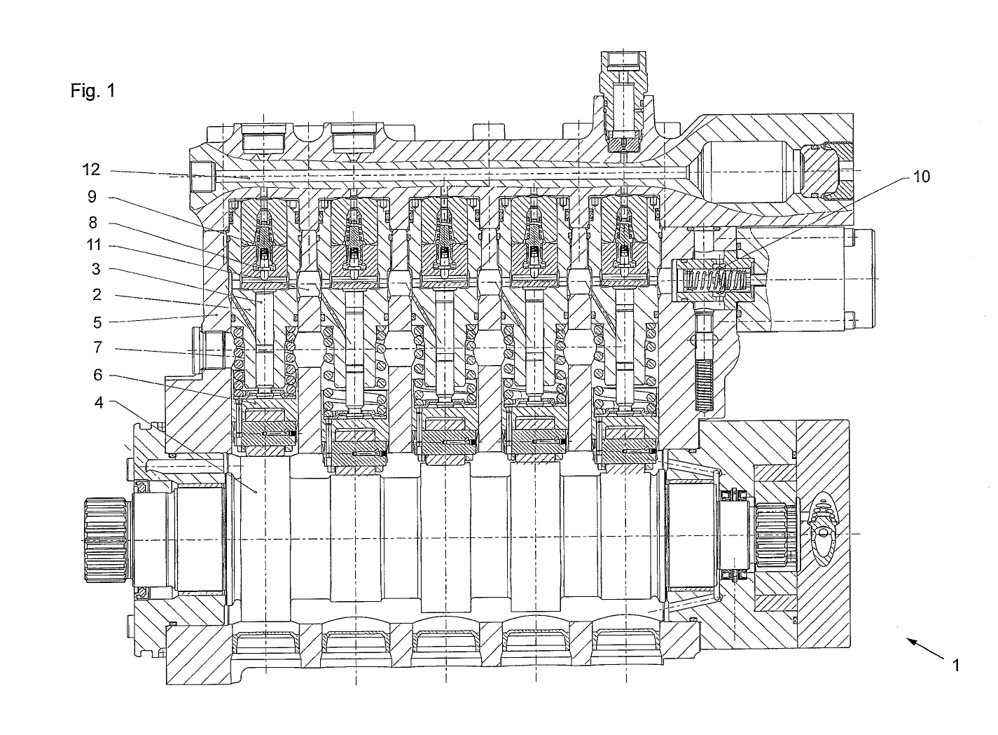

FIG. 1 shows the basic construction of a high-pressure pump 1 for a common rail fuel injection system comprising five pump elements that can each be considered a component or device which conducts a high-pressure medium. Each pump element includes a pump cylinder 2 and a pump piston 3. A cam shaft 4 driven by the internal combustion engine is mounted in a pump housing 5 and moves the pump pistons 3 up and down in the pump cylinders 2 via roller tappets 6. The contact between roller tappet 6 and cam is maintained by compression springs 7. During the downward stroke of the pump piston 3, the fuel quantity determined by the metering unit 10 is suctioned out of the pump suction chamber 11, which extends around the pump elements in the longitudinal direction of the pump housing, via a suction valve 8 and is subsequently pressed into the rail 12 via a pressure valve 9 during the upward stroke.

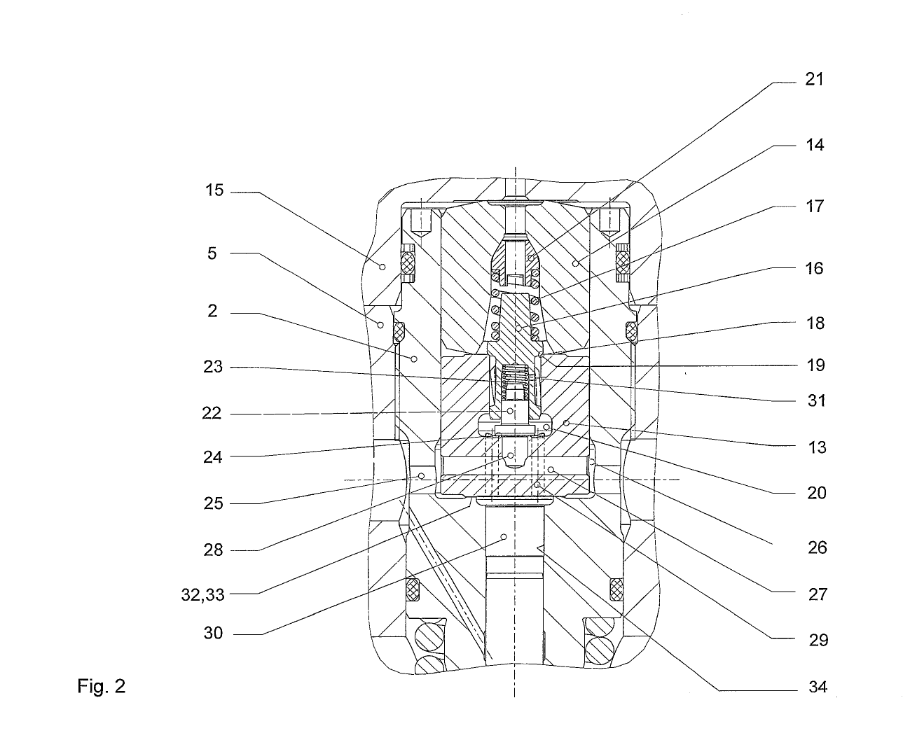

In FIG. 2, a cross section through a valve unit corresponding to the prior art is depicted. A valve carrier 13 and above it a pressure fitting 14 are disposed in the upper region of the pump cylinder 2, which are pressed in a sealing manner into the pump cylinder 2 by means of the pump housing head 15 that is screwed to the pump housing 5. The pressure valve member 16 is guided in the valve carrier 13 so as to be axially displaceable. Pressure is applied by the pressure valve spring 17 on the pressure valve seat 18 thereof against the conical seating surface 19 of the valve carrier 13. Lateral flat portions on the pressure valve member 16 enable fuel to flow out of the valve chamber 20 in the direction of the pressure valve seat 18. The pressure valve spring 17 is supported on a spring plate 21 mounted in the pressure fitting 14. The suction valve member 22 is guided in an axially displaceable manner in a bore of the pressure valve member 16 and is pressed against the suction valve seat 24, which is configured as a flat seat, by the suction valve spring 23.

During the downward stroke of the pump piston 3, the fuel metered by the metering unit 10 into the pump suction chamber 11 is suctioned via the inlet bore 25 and the element suction chamber 26, the suction bore 27 and the inlet bore 28, further via the suction valve seat 24 which is opening, the valve chamber 20 and the pressure ducts 29 into the pump chamber 30 above the pump piston 3. In the subsequent downward stroke of the pump piston 3, the suction valve 8 closes and the fuel is pressed out of the pump chamber 30 into the rail 12 via the pressure ducts 29, the valve chamber 20 and the lateral flat portions on the pressure valve member 16, the pressure valve seat 18 which is opening, the interstices between the coils of the pressure valve spring 17 and the central bores in the spring plate 21 and in the pressure fitting 14. Transverse bores 31 in the pressure valve member 16 prevent the build-up of an air cushion in the bore, which contains the suction valve spring 23, located above the suction valve body 22. The stroke of the pressure valve member 16 is delimited by a stroke limit stop on the spring plate 21.

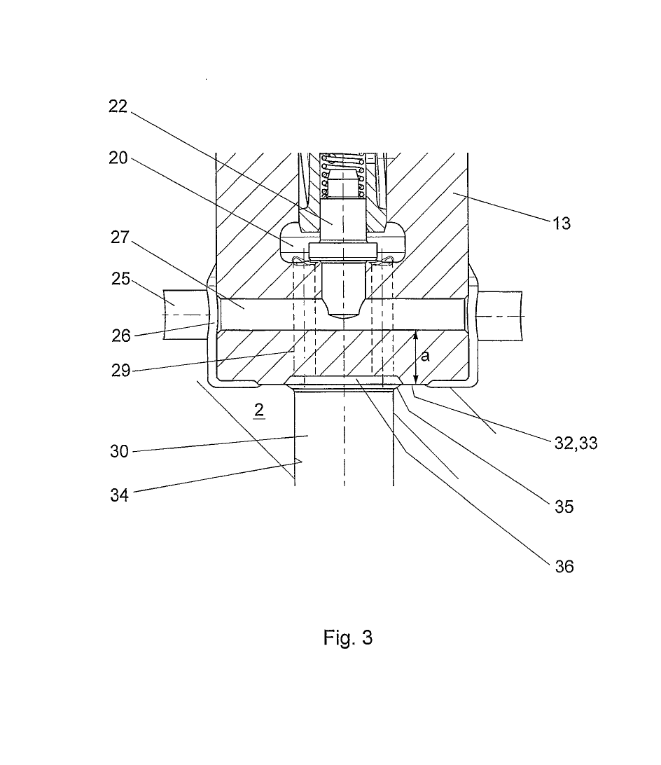

In FIG. 3, the embodiment according to the invention is now depicted in the region of the sealing surfaces 32 and 33 of the valve carrier 13 and the pump cylinder 2 which interact with one another. It can be seen that the material thickness “a” between the suction bore 27 and the sealing surface 32 of the valve carrier 13 was enlarged and is preferably 1.25 times, preferably 1.5 times, the diameter of the suction bore 27. In comparison to the embodiment according to FIG. 2, an annular, conical surface 35 which widens out towards the sealing surface 33 is now furthermore provided at the transition between the cylindrical interior surface 34 of the pump cylinder 2 and the sealing surface 33 of the pump cylinder 2; thus enabling the sealing surface 33 to be better supported on the interior sealing diameter.

It can furthermore be seen in FIG. 3 that the inlet bore 25 leading to the suction chamber 26 extends substantially coaxially in relation to the suction bore 27. The inlet bore 25 was, in comparison to FIG. 2, therefore moved upwards in order to make room for the enlarged wall thickness “a” of the valve carrier 13.

Finally, the pressure ducts 29 open into a plane which is displaced axially to the rear in relation to the sealing surface plane so that an interstice 36 forms, the inside diameter of which preferably corresponds to the inside diameter of the pressure chamber 30 so that the fluid pressure prevailing respectively in the valve carrier 13 and in the pump cylinder 2 is brought to bear on the same diameter and correspondingly brings about a radial expansion of the valve carrier 13 and the pump cylinder 2 to the same extent.

1. A device which conducts high-pressure medium, the device comprising a first component (13) with at least one pressure duct (29) and a second component (2) with a pressure chamber (30), the first component having a first annular sealing surface (32), which surrounds a mouth of the at least one pressure duct (29), and the second component having a second annular sealing surface (33), which surrounds the rim of the pressure chamber (30), wherein the first and second annular sealing surfaces interact areally with one another to form a sealing point, wherein a cross-sectional area of the pressure duct (29) is smaller than a cross-sectional area of the pressure chamber (30), characterized in that pressure-induced radial expansion of the first and second annular sealing surfaces (32, 33) is substantially equal.

2. The device according to claim 1, characterized in that the mouth of the at least one pressure duct (29) in the first component is displaced axially to the rear relative to the first annular sealing surface (32).

3. The device according to claim 1, characterized in that the at least one pressure duct (29) opens into an interstice (36) having a cross-sectional area which is enlarged with respect to the pressure duct (29), wherein the interstice (36) is surrounded by the first annular sealing surface (32).

4. The device according to claim 1, characterized in that the device is a pump element for a common rail high-pressure pump comprising a pump cylinder (2) which forms the second component, a pump piston (3) and at least one valve unit, wherein the valve unit has a suction valve (8) and a pressure valve (9), the suction valve having a suction valve member (22) which can be pressed against a suction valve seat (24), and the pressure valve having a pressure valve member (16) which can be pressed against a pressure valve seat (211, 18), and the suction valve member and the pressure valve member are movably disposed in a valve carrier (13) which forms the first component, wherein medium is suctioned from a suction chamber (26) of the pump element via the suction valve (8) during a downward stroke of the pump piston (3) and medium is discharged via the pressure valve (9) during an upward stroke of the pump piston (3), wherein the suction chamber (26) is connected to the suction valve (8) via a suction bore (27) which passes through the valve carrier (13), and a pump chamber (30), which is formed in the pump cylinder (2), forms the pressure chamber and is connected to the pressure valve (9) via a plurality of pressure ducts (29) which extend transversely to the suction bore (27) and are formed in the valve carrier (13), wherein the second annular sealing surface surrounds mouths of the pressure ducts (29), and the first annular sealing surface surrounds the rim of the pump chamber (30).

5. The device according to claim 4, characterized in that a material thickness, as seen in cross section, between the suction bore (27) and the first sealing surface (32) of the valve carrier (13) is at least 1.25 times the diameter of the suction bore (27).

6. The device according to claim 4, characterized in that a conical or convex surface (35) which widens out towards the second annular sealing surface (33) is provided at a transition between a cylindrical interior surface (34) and the second annular sealing surface (33) of the pump cylinder (2).

7. The device according to claim 4, characterized in that an inlet bore (25) leading to the suction chamber (26) extends substantially coaxially in relation to the suction bore (27).

8. The device according to claim 1, characterized in that the second annular sealing surface (33) of the second component (2) has an angle exaggeration of 0-3 μm.

9. The device according to claim 1, characterized in that the first and second annular sealing surfaces (32, 33) which interact with one another are machined by grinding.

10. The device according to claim 4, characterized in that the pump cylinder (2) consists of steel 100Cr6.

11. The device according to claim 4, characterized in that a material thickness, as seen in cross section, between the suction bore (27) and the first sealing surface (32) of the valve carrier (13) is at least 1.5 times the diameter of the suction bore (27).

12. The device according to claim 2, characterized in that the at least one pressure duct (29) opens into an interstice (36) having a cross-sectional area which is enlarged with respect to the pressure duct (29), wherein the interstice (36) is surrounded by the first annular sealing surface (32).

13. The device according to claim 12, characterized in that the device is a pump element for a common rail high-pressure pump comprising a pump cylinder (2) which forms the second component, a pump piston (3) and at least one valve unit, wherein the valve unit has a suction valve (8) and a pressure valve (9), the suction valve having a suction valve member (22) which can be pressed against a suction valve seat (24), and the pressure valve having a pressure valve member (16) which can be pressed against a pressure valve seat (18), and the suction valve member and the pressure valve member are movably disposed in a valve carrier (13) which forms the first component, wherein medium is suctioned from a suction chamber (26) of the pump element via the suction valve (8) during a downward stroke of the pump piston (3) and medium is discharged via the pressure valve (9) during an upward stroke of the pump piston (3), wherein the suction chamber (26) is connected to the suction valve (8) via a suction bore (27) which passes through the valve carrier (13), and a pump chamber (30), which is formed in the pump cylinder (2), forms the pressure chamber and is connected to the pressure valve (9) via a plurality of pressure ducts (29) which extend transversely to the suction bore (27) and are formed in the valve carrier (13), wherein the second annular sealing surface surrounds mouths of the pressure ducts (29) and the first annular sealing surface surrounds the rim of the pump chamber (30).

14. The device according to claim 13, characterized in that a material thickness, as seen in cross section, between the suction bore (27) and the first sealing surface (32) of the valve carrier (13) is at least 1.25 times the diameter of the suction bore (27).

15. The device according to claim 14, characterized in that a conical or convex surface (35) which widens out towards the second annular sealing surface (33) is provided at a transition between a cylindrical interior surface (34) and the second annular sealing surface (33) of the pump cylinder (2).

16. The device according to claim 15, characterized in that an inlet bore (25) leading to the suction chamber (26) extends substantially coaxially in relation to the suction bore (27).

17. The device according to claim 16, characterized in that the second annular sealing surface (33) of the second component (2) has an angle exaggeration of 0-3 μm.

18. The device according to claim 17, characterized in that the first and second annular sealing surfaces (32, 33) which interact with one another are machined by grinding.

19. The device according to claim 14, characterized in that the pump cylinder (2) consists of steel 100Cr6.
